(19) United States
(12) Patent Application Publication
(10) Pub. No.: US 2013/0129117 A1
(43) Pub. Date: May 23, 2013

(54) AUDIO AMPLIFICATION CIRCUIT

(71) Applicants: Henrik THOMSEN, Holte (DK); Kristian HANSEN, Rodovre (DK); Jens HENRIKSEN, Charlottenlund (DK)

(72) Inventors: Henrik THOMSEN, Holte (DK); Kristian HANSEN, Rodovre (DK); Jens HENRIKSEN, Charlottenlund (DK)

(21) Appl. No.: 13/681,952

(22) Filed: Nov. 20, 2012

Related U.S. Application Data
(60) Provisional application No. 61/562,168, filed on Nov. 21, 2011.

(51) Int. Cl. H04R 3/00

(52) U.S. Cl. CPC H04R 3/00
USPC 381/111; 381/120; 381/121

(57) ABSTRACT

Disclosed is an audio amplification circuit comprising: an input terminal for receipt of an audio input signal; a first preamplifier having an input operatively coupled to the input terminal and operable to provide a first amplified audio signal with a first signal amplification; a second preamplifier having an input operatively coupled to the input terminal and operable to provide a second amplified audio signal with a second signal amplification, smaller than the first signal amplification; a switch having a first input operatively coupled to the first preamplifier, a second input operatively coupled to the second preamplifier, and an output; an analogue-to-digital converter operatively coupled to the output of the switch and operable to provide a digital audio signal; a signal selection circuit operable to control the switch to selectively provide one of the first and second amplified audio signals on the output of the switch.

The present invention benefits from priority afforded by U.S. patent application Ser. No. 61/562,168, entitled “Audio Amplification Circuit,” filed Nov. 21, 2011, the disclosure of which is incorporated herein in its entirety.

The present invention relates to an audio amplification circuit with first and second signal channels with different signal amplifications based on a common audio input signal. The invention also relates to a method of amplifying a common audio input signal with different signal amplifications to provide first and second audio signals with different amplification. The invention further relates to a semiconductor die or substrate comprising such an audio amplification circuit and a miniature capacitive microphone comprising such an audio amplification circuit.

### BACKGROUND

Acceptable handling of audio signals with very large dynamic range presents significant challenges to audio amplification and processing circuits and systems, in particular for audio amplification and processing circuits targeted for portable devices and applications such as mobile terminals, hearing instruments, headsets, sound recording cameras etc.

Since portable devices are powered from battery sources severe constraints as to a maximum acceptable power consumption of the audio amplification circuit is typically imposed. To further worsen the situation, there typically exist similar constraints on a maximum DC supply voltage that can be provided to the audio amplification and processing circuitry. The audio amplification and processing or conditioning circuitry often comprise preamplifiers, analogue-to-digital converters, active filters, voltage supply regulators, etc. The maximum DC power supply voltage, and therefore AC signal voltage swing, will often be limited to a voltage below a maximum rated voltage of the particular semiconductor process used to implement the signal processing or conditioning circuitry on. Furthermore, a continuing trend of shrinking minimum feature sizes of active devices on semiconductor dies and circuits in general and CMOS processes in particular, leads to a constant decline of the maximum DC power supply voltage these active devices can withstand or tolerate. Audio amplification systems and circuitry, such as audio signal controllers and audio amplification circuits, which can operate on these declining DC power supply voltages without audio performance degradation, are therefore highly desirable. It is generally undesirable to reduce performance of the audio amplification system, for example by lowering dynamic range or amplification of a preamplifier, to accommodate large audio input signals despite the decrease of the DC power supply voltage. The DC power supply voltage may be less than 2 Volt or even less than 1.5 Volt. The audio amplification system should therefore be able to provide unimpaired audio quality for low level signals and high level signals at the decreased or lowered DC power supply voltage.

An interesting application of the present audio amplification circuit is to amplify and digitize audio signals in miniature microphones where microphone transducer elements are capable of generating audio input signals with a very large dynamic range. The microphone transducer elements may comprise a capacitive electret or condenser transducer of a miniature ECM, that is capable of handling very high sound pressure levels and generate correspondingly large transducer signals without significant distortion. These very high sound pressure levels, for example peak sound pressure levels above 110, 120 or 130 dB SPL, can originate from different types of acoustic sources for example car door slamming, wind noise and augmented live music performances. However, prior art microphone amplification systems have not been capable of handling the entire dynamic range of these transducer signals in an entirely satisfactory manner, e.g., without increasing equivalent input noise of the miniature microphone or overloading the miniature microphone at large sound pressure levels or both.

Accordingly, there is a need in the art for microphone amplification circuits and systems capable of handling the entire dynamic range of the transducer signals generated by microphone transducer elements, or other audio source signals with large dynamic range, without excessive distortion or noise within the previously discussed constraints on DC power supply voltage and power consumption dictated by portable or battery-powered devices and applications.

### PRIOR ART

In general, prior art microphone amplification circuits for miniature microphones have been designed to accommodate sound pressure levels up till a maximum limit around 110 dB SPL or lower where preamplifier non-linearity or clipping has limited further increase of microphone output voltage. This has been considered acceptable in view of the relatively rare occurrence of sound pressure levels above this maximum limit. To protect the microphone amplification circuit against excessively large transducer signals generated by large low-frequency sound pressures it has been practiced to introduce a highpass filter with a corner or cut-off frequency located between for example 100 Hz and 200 Hz in the microphone amplification circuit or by introducing an acoustical highpass filter in a microphone transducer element itself for example by means of an appropriately dimensioned hole in a diaphragm.

U.S. Pat. No. 6,271,780 describes a gain ranging A/D converter for microphone applications having two separate gain paths provided as a low-gain path and a high-gain path each including a preamplifier coupled to an analogue-to-digital converter to provide respective digital signals. The gain of the first and second preamplifiers differs with 24 dB. The gain ranging A/D converter furthermore comprises summing device performing a mixing or blending operation on the respective digital signals supplied by the low and high-gain paths. A proportionality device controls an amount of gain applied to each of the digital signals to be summed from the low and high-gain paths in accordance with a summing profile. The amount of gain of each of the digital signals to be summed is determined by comparing a level of the digital signal of the high-gain path to upper and lower preset thresholds.

The WM8737L Product Sheet describes a low power stereo audio ADC for portable applications. The left and right signal channels have separate microphone signal inputs and each signal channel comprises a gain programmable microphone preamplifier operatively coupled to an analogue-to-digital converter through a programmable gain amplifier (PGA). The gain of each PGA is logarithmically adjustable from −97 dB to +30 dB in 0.5 dB steps by writing appropriate values to a PGA gain control register. The stereo audio ADC comprises a zero-cross detector for each channel to, in one mode of operation, only change respective gains of the programmable microphone preamplifier and the PGA when the input signal of a channel is at zero.

US Patent Application Publication No. US 2011/0026739 discloses an audio amplification system comprising an audio amplification circuit and an audio signal controller. The audio amplification circuit comprises first and second signal channels comprising respective preamplifiers and analogue-to-digital converters. Based on a common audio input signal, the first and second signal channels generate respective digital audio signals with different signal amplifications. Even though this prior art systems addresses a number of issues related to earlier prior art systems, it remains desirable to reduce the power consumption of an audio amplification system. It is further generally desirable for many applications to reduce the area required for implementing the audio amplification circuit.

### SUMMARY

According to a first aspect, disclosed herein are embodiments of an audio amplification circuit comprising a first and a second preamplifier. The first preamplifier has an input operatively coupled to an input terminal of the audio amplification circuit for receipt of an audio input signal and is operable to provide a first amplified audio signal with a first signal amplification. The second preamplifier has an input operatively coupled to an input terminal of the audio amplification circuit for receipt of an audio input signal and is operable to provide a second amplified audio signal with a second signal amplification, smaller than the first signal amplification. A switch has a first input operatively coupled to the first preamplifier, a second input operatively coupled to the second preamplifier, and an output. An analogue-to-digital converter is operatively coupled to the output of the switch and is operable to provide a digital audio signal. A signal selection circuit is operable to control the switch to selectively provide one of the first and second amplified audio signals on the output of the switch. In some embodiments, the first and second preamplifiers are operatively coupled to the same input terminal.

The first and second amplified audio signals are derived from a common input signal in form of the audio input signal to provide the first and second amplified audio signals from respective ones of first and second signal channels or paths. The first signal amplification is defined as the gain between the first amplified audio signal and the audio input signal and the second signal amplification as the gain between the second amplified audio signal and the audio input signal. Since the second signal amplification is smaller than the first signal amplification, preferably significantly smaller, the output of the second preamplifier will be capable of handling higher levels of the audio input signal without distortion due to the lower output voltage level. This is naturally particularly pronounced if the first and second preamplifiers are of similar or identical design powered by essentially identical DC power supply voltages. This is a common situation because preamplifiers suitable for low-power operation are preferably constructed with rail-to-rail output voltage swing capability or at least an output voltage swing capability close thereto. To create an advantageous difference between the overload limits of the first and second parallel signal paths or channels, the second signal amplification may be at least 10 dB, preferably more than 20 dB, or more than 40 dB, smaller than the first signal amplification throughout a frequency range between 300 Hz and 3 kHz. This constraint may alternatively be defined at a single or at a few relevant reference frequencies inside the audio band between 20 Hz and 20 kHz, for example at 1 kHz or as an average determined over frequencies 300 Hz, 1 kHz and 3 kHz.

As the first and second preamplifiers are connected, via the switch, to a common analogue to digital converter, only a single analogue-to-digital converter is needed for conversion of a single amplified audio signal to a digital audio signal and any time, thus reducing the complexity and power consumption of the audio amplification circuit considerably. Furthermore, separate portions of the first and second signal channels or paths are kept relatively short, and a large part of the signal processing may be performed in a single signal path, thus reducing the space requirements of the resulting circuit.

The first signal channel can often be considered a normal sensitivity channel well-adapted to amplify or process low levels and normal levels of the audio input signal without introducing unacceptable noise at small or zero audio input signal levels. The second signal channel is, due to its lower signal amplification, but preferably essentially same output voltage swing capability, capable of handling audio input signals with levels for example 10 dB or 20 dB larger than the first signal channel before the second signal channel reaches its overload or clipping limits. The overload or clipping limit of each of the first and the second signal channel may conveniently be defined as the signal level where the digital audio signal in question reaches a total harmonic distortion of 3% measured with a 1 kHz sine signal applied to the input terminal.

Some embodiments of the present audio amplification circuit may comprise one or more additional signal channels for example a third signal channel providing a third amplified audio signal with a signal amplification in-between the first and second signal amplifications. The switch may in this situation be adapted to switch between these three different signal channels based on an estimated level of anyone of the first, second or third amplified audio signals.

The input terminal may be adapted for receipt of analogue audio input signals originating from various types of audio sources or generators such as recorded music and speech signals provided as line level signals supplied to the input terminal by a low impedance signal source. The audio input signal may alternatively be supplied by an electro-acoustical audio transducer such as a microphone transducer element directly coupled to the input terminal. Naturally, the amplification circuit may comprise two parallel input terminals receiving the same audio input terminal. The microphone transducer element may comprise a condenser microphone, e.g. a micro-electromechanical (MEMS) condenser microphone, e.g. shaped and sized for mobile terminal applications. Other examples of a microphone transducer element may comprise an electrodynamic transducer element or a capacitive electret or condenser transducer element of a miniature ECM which constitute an extremely large generator impedance corresponding to a capacitor with a value between 0.5 and 2 pF.

In some embodiments of the invention, an attenuator is operatively coupled in-between the input terminal of the audio amplification circuit and an input terminal of the second audio preamplifier. By an appropriate design of the attenuator it can significantly reduce the level of the audio input signal applied to the input terminal of the second preamplifier compared to the level on the input terminal. This leads to a beneficial shielding of input transistors or other active devices of the second preamplifier from peak audio signal voltages rising above or below DC power supply voltage rails of the second preamplifier. It is furthermore advantageous if the attenuator comprises a voltage divider formed by passive components such as a resistive or capacitive voltage divider since passive components are far better suited than active semiconductor devices, such as CMOS transistors, to handle very large levels of audio signal voltages in a linear manner.

Alternatively, the audio amplification circuit may receive inputs from two separate input audio transducers wherein the first preamplifier receives an audio signal from a first input audio transducer and the second preamplifier receives an audio signal from the second input audio transducer, wherein the second input audio transducer has a lower sensitivity than the first input audio transducer. The input audio transducers may be respective MEMS microphones that may be included on the same die.

The application of an attenuator based on a capacitive voltage divider is very useful in condenser microphone applications, for example miniature ECMs, because the substantially capacitive load presented by the capacitive voltage divider to a capacitive or condenser transducer element of the condenser microphone leads to a substantially frequency independent attenuation of a transducer signal. Furthermore, capacitors of the capacitive voltage do contribute with thermal noise to the audio input signal in contrast to a resistor based attenuator, in particular a high impedance attenuator required by the extremely large generator impedance of a condenser transducer element of a miniature ECM. In addition, appropriate capacitor values of the capacitors of the capacitive voltage divider can be formed on the integrated semiconductor substrate with minimal die area consumption and therefore at a low cost.

As mentioned above, the attenuator protects the input of the second preamplifier for being subjected to very large levels of the audio input signals so as to allow the second preamplifier to operate substantially linearly even at these large audio signal levels which may correspond to sound pressure levels above 110 or 120 dB SPL. A substantially linear operation, or at least quasi-linear operation in case of a build-in Automatic Gain Control function, of the second preamplifier across a desired dynamic range of the audio input signal ensures the second preamplifier responds rapidly and predictably to the large levels of the audio input signal. One advantage of this feature is that it is possible to obtain an accurate indication of the actual level of the audio input signal for use in an associated level estimator operating on the digital audio signal.

A very useful embodiment of the present audio amplification circuit is specifically well-suited for use in condenser microphone applications where the generator impedance of a capacitive transducer element normally is very high which may lead to unwanted transducer signal attenuation or signal loss by the coupling to an audio amplification circuit unless appropriate impedance characteristics are provided at its input terminal. As mentioned above, condenser or capacitive transducers element or capsule of a miniature ECM suited for mobile terminal applications exhibits extremely high generator impedances essentially corresponding to purely capacitive generator impedances equivalent to a capacitor of 0.5 pF to 2 pF. Accordingly, this embodiment of the audio amplification circuit has an input impedance at the input terminal which is larger than 100 MΩ, preferably larger than 1 GΩ, even more preferably larger than 10 GΩ measured at 1 kHz. Input impedances in the above-mentioned preferred range can for example be accomplished by an appropriate choice of semiconductor process technology, such as MOS, CMOS or BiCMOS technology, and/or appropriate circuit design techniques. In one useful embodiment, which exhibits very large input impedance at the input terminal, respective input stages of the first and second preamplifiers are based on CMOS transistors.

Alternatively, requirements to the input impedance at the input terminal of the audio amplification circuit in applications involving electrical coupling to a capacitive transducer elements can be specified in terms of a capacitive component of the input impedance at the input terminal. The capacitive component of the input impedance at the input terminal is preferably smaller than 500 fF, preferably smaller than 200 fF, even more preferably smaller than 100 fF, measured at 1 kHz. If the audio amplification circuit comprises the previously-mentioned capacitive voltage divider, the above-mentioned advantageous ranges for the capacitive component of the input impedance at the input terminal can be complied with by appropriate selection of capacitances in the capacitive voltage divider. The capacitive voltage divider is particular advantageous for coupling to a miniature condenser transducer element since it provides frequency independent attenuation of the audio input signal supplied to the input terminal by a microphone transducer element. A capacitance of the smallest capacitor of the capacitive voltage divider is preferably less than 500 fF, or even more preferably less than 100 fF, to minimize loading of the audio input signal by providing large input impedance.

In one embodiment, the capacitive voltage divider comprises first and second cascaded capacitors coupled in-between the input terminal and a signal ground node such as circuit ground or a DC supply or DC reference voltage. A midpoint or leg between the first and second cascaded capacitors is operatively coupled to the input of the second preamplifier. The first and second capacitors values are selected to be around 100 fF and 900 fF, respectively, to provide approximately 20 dB of attenuation of the audio input signal before it reaches the input of the second preamplifier. The cascade of the first and second capacitors cooperate to introduce a capacitive load of around 90 fF on the input terminal.

The difference between the first and second signal amplifications may in some embodiments be created exclusively by a signal attenuation of the attenuator. This has the advantageous effect that the first and second preamplifiers may be of substantially identical design and therefore exhibit essentially identical small signal transfer functions across a predetermined frequency range of the audio spectrum for example between 100 Hz and 10 kHz. The essentially identical small signal transfer functions of the first and second preamplifiers support phase matching of the first and second digital audio signals. As will be explained below, there are certain advantages associated with providing simultaneous zero-crossings of the first and second amplified audio signals in connection with switching forth and back between these. Obtaining an essentially identical small signal transfer function may further be supported by matching the relevant circuit components such as capacitors and transistors.

In alternative embodiments, the difference between the first and second signal amplifications may be created by a combination of signal attenuation provided by the attenuator and a gain difference between the first and second preamplifiers. The second preamplifier may function as a unity gain buffer or as an amplifier with a considerable gain for example more than 10 dB or more than 20 dB, throughout at least a portion of the audio frequency range such as between 300 Hz and 3 kHz. In both cases, the second preamplifier preferably has high input impedance, preferably larger than 100 MΩ, such as larger than 1 GΩ or even larger than 10 GΩ measured at 1 kHz to ensure minimal loading of the audio input signal or minimal loading of the leg of the attenuator.

In yet another embodiment where the small signal transfer functions of the first and second preamplifiers differ, the small signal transfer function of the second preamplifier comprises a pole at a lower frequency, such as below 20 Hz or 10 Hz, than a lowest or smallest pole of the small signal transfer function of the first preamplifier. The pole of the second preamplifier may advantageously be set to a much lower frequency than the lowest pole of the first preamplifier such as 10 times lower.

The first or second first preamplifier may have anyone of a plurality of circuit topologies known in the art. The first and second preamplifier may have essentially identical circuit topologies to facilitate matching of their small signal transfer functions through the audio frequency range or at least a part thereof. The first or second preamplifier may comprise a high-pass filter.

In a number of useful embodiments, the first preamplifier and/or the second preamplifier comprises a differential amplifier having a non-inverting input operatively coupled to the input terminal of the audio amplification circuit for receipt of the audio input signal. A feedback network may be coupled between an output and an inverting input of the first and/or second preamplifier or between an output of the first preamplifier and an inverting input of the second preamplifier. This preamplifier configuration provides large input impedance at the non-inverting input coupled to the audio input signal by isolating the feedback network there from. In an even further advantageous embodiment, the feedback network establishes a lowpass transfer function from the output of the differential amplifier to the inverting input of the first or the second preamplifier. This may be accomplished by selecting a suitable configuration of capacitors and resistive components in the feedback network. Consequently, a high-pass small signal transfer function which is useful for attenuating low-frequency noise in the audio input signal and for suppression of effects of DC offsets at the input of the first or second preamplifier is provided. To facilitate integration on a semiconductor substrate, resistive components of the feedback network may comprise MOS transistors operating or biased in their respective triode regions. In other embodiments of the invention, the first preamplifier and/or the second preamplifier comprise respective single-ended inputs operatively coupled to the input terminal of the audio amplification circuit and respective differential outputs operatively coupled, via a switch, to a differential input of the analogue-to-digital converter. In yet another embodiment, the first or second preamplifier has differential input and differential output.

The analogue-to-digital converter may comprise a sigma-delta converter generating the digital audio signal at an oversampled sampling frequencies or at a rate such as a sampling rate between 1 MHz and 10 MHz. Alternatively, a non-oversampling analogue-to-digital converter, for example operating with a sampling frequency in the range between 16 and 48 kHz, may be applied to digitize respective analogue signals supplied by the first and second preamplifiers and to deliver the digital audio signal. Such a non-oversampling analogue-to-digital converter may comprise successive approximation or flash converters.

If the analogue-to-digital converter comprises an oversampled sigma-delta converter, the present audio amplification circuit may comprise a decimation filter configured for receipt and down-sampling of the digital audio signal from an oversampled sampling rate or frequency to a reduced or Nyquist sampling frequency. The sampling frequency of the digital audio signal after down-sampling to Nyquist sampling frequency may be set to a value between 8 kHz and 96 kHz such as between 16 kHz and 48 kHz. The amount of down-sampling may be a trade-off between the additional circuitry required for the down-sampling and a reduced complexity of the subsequent control logic. The down-sampling of the digital audio signal may be accompanied by lowpass filtering to eliminate or attenuate high-frequency noise and distortion products above the reduced or Nyquist sampling frequency in the oversampled digital audio signal. In the alternative, the subsequent signal selection and scaling circuit may receive and process the signal at the oversampled sampling rate provided by the sigma-delta converter. The reliability of the signal feature estimation described herein is likely to be improved once the high-frequency noise has been suppressed or eliminated.

The amplitude of the digital audio signal is preferably scaled responsive to which one of the first and second amplified audio signals is transmitted to the analogue-to-digital converter so as to possess essentially identical levels irrespective of which one of the amplified audio signals is transmitted to the analogue-to-digital converter. To this end, according to some embodiments, the present audio amplification circuit comprises a digital signal scaling function adapted to scale the digital audio signal with a preset or adaptive gain factor to compensate for an amplification difference between the first and second signal amplifications. The scaling function is operative to equalize the level of the digital audio signal before providing the digital audio signal at an output of the audio amplification circuit.

To this end, the digital signal scaling function may be operationally coupled to the signal selection circuit and receive a control signal from the signal selection circuit indicative of whether the digital audio signal originates from the first or the second preamplifier. In some embodiments the digital scaling function may be integrated into the signal selection circuit. The digital audio signal may be selectively scaled responsive to the received control signal, e.g. such that the digital audio signal is scaled only when the control signal indicates that the digital audio signal is based on an output from a selected one of the first and the second preamplifier. Alternatively the digital audio signals may be scaled irrespective of whether it originates from the first or second preamplifier, but with respective preset or adapted gain factors. The or each gain factor may have a preset value according to a priori knowledge of an amplification difference between the first and second signal channels, or the gain factor may be determined during a factory calibration of audio amplification circuit. According to yet another embodiment, the gain factor is adaptively determined during operation of the audio amplification circuit. In some embodiments, a change of the gain factor responsive to the control signal may be delayed by a suitable delay relative to the switching between transmitting the first or second amplified audio signal to the analogue-to-digital converter so as to compensate for signal delays introduced by the analogue-to-digital converter.

Since the signal selection circuit is included in the audio amplification circuit, the audio amplification circuit may provide a single digital audio output signal, and the circuitry receiving the digital audio signal does not have to be aware of any threshold or the like for switching between the channels. Consequently, the design of subsequent signal processing circuitry receiving the digital audio signal at the output of the present audio amplification circuit does neither have to consider the gain differences between the first and second signal paths nor the switching process performed by the audio amplification circuit. This may allow for a less complex implementation of subsequent signal processing circuitry.

In some embodiments, the gain of the first signal channel may even be and compensate for this additional gain in the digital domain, e.g. by the gain scaling circuit. This may effectively reduce the noise requirement imposed on the analogue-to-digital converter and parts of the first preamplifier.

The integrated semiconductor circuit may advantageously comprise an overload protection or signal limiting feature coupled to the input pad or terminal. This feature protects both active and passive components, such as input transistors and attenuator components like resistors and capacitors, on the integrated semiconductor circuit against overvoltage conditions. Overvoltage conditions may lead to destruction or malfunctioning of the active or passive components due to excessive substrate currents. According to a preferred embodiment, the integrated semiconductor circuit comprises two or more cascaded non-linear elements, such as diodes or diode-coupled transistors, operatively coupled between the input terminal and at least one of {a DC power supply rail, a DC reference voltage} to clamp the audio input signal at a first limiting level. The DC power supply rail may comprise a positive or negative DC power supply voltage or ground (GND). The DC reference voltage may comprise a regulated DC voltage or bandgap derived DC voltage any other reasonably well-defined and stable DC voltage of the integrated semiconductor circuit. The first limiting level may be set to a numerical value of between about 1.0 Volt and 2.5 Volt for example by using between two and five cascaded diodes or diode-coupled transistors as the non-linear elements. One embodiment utilizes two sets or strings of non-linear elements mounted in anti-parallel configuration where each set comprises two or more cascaded non-linear elements. In this embodiment, the two sets of anti-parallel non-linear elements set both the first limiting level and a second limiting level. By appropriate selection of number and type of the cascaded non-linear elements the audio input signal can be clamped at two differing limiting levels for example a first limiting level between 1.0 Volt and 2.5 Volt above a quiescent or DC bias voltage at the input terminal and second limiting level between 1.0 Volt and 2.5 Volt below said quiescent or DC bias voltage at the input terminal.

The input of the first preamplifier, or even the second preamplifier, may additionally be provided with a separate overload protection or signal clamping to prevent the preamplifier in question from being driven too far into an overload state. This type of overloading may result in long recovery or settling time of the first and/or second preamplifier(s) after the level of the audio input signal has returned to a level below the level causing the overload state. According to one such embodiment, a single or several cascaded non-linear semiconductor elements, such as a diode or a diode-coupled transistor, are coupled to an input of the first preamplifier to clamp the input signal at a first preamplifier limiting level. The first limiting level is numerically larger than the first preamplifier limiting level such as between 0.5 and 2.0 volt larger. This difference in absolute or numerical limiting levels may be accomplished by using different numbers of cascaded non-linear elements in the respective networks at the input terminal and at the first preamplifier input.

In case the integrated semiconductor circuit comprises the previously-mentioned externally accessible output terminal for signal transmission, flexibility and interoperability of the present audio amplification circuit may be enhanced when the audio amplification circuit comprises a digital audio interface operatively coupled in-between the digital audio signal and the externally accessible output terminal. The digital audio interface may be configured to convert the digital audio signal at the reduced or Nyquist sampling rate into a bit stream format, a digital audio stream compliant with a standardized data communication/digital audio protocol such as I²S, S/PDIF, AES/EBU, SLIMbus™, or the like. In some embodiments, the audio amplification circuit may comprise a digital reshaper adapted to execute steps of: receiving the digital audio signal at a reduced or Nyquist sampling frequency, and reshaping the digital audio signal and convert the digital audio signal into a standardized N-bit format (N typically being a positive integer) such as two's complement etc.

In some embodiments, the audio amplification circuit comprises a clock input terminal for receipt of an external clock signal and the sampling frequency of the analogue-to-digital converter is set by an internal clock signal of the audio amplification circuit derived from the external clock signal. This embodiment is particularly useful where an associated audio signal controller resides within a portable terminal in form of an appropriately programmed or configured Digital Signal Processor (DSP) with data interface terminal(s) operatively coupled to the externally accessible output terminal for receipt of the digital audio signal. The external clock signal may be supplied from the DSP of the portable terminal to the clock input terminal of the audio amplification circuit and transmission of the digital audio signal via the externally accessible output terminal may be synchronized to the external clock signal allowing the DSP of the portable terminal to act as a master for the transmission process.

The signal selection circuit may be configured to control a switching scheme or algorithm as discussed in detail below. The signal selection circuit may be adapted to execute steps of:
estimating a signal feature of the digital audio signal
comparing the estimated signal feature with a predetermined feature criterion,
controlling the switch to switch between conveying the first or second amplified audio signal to the analogue-to-digital converter based on the comparison between the estimated signal feature and the predetermined feature criterion, at a detected zero-crossing of the first amplified audio signal and/or the second amplified audio signal.

Accordingly, some embodiments of the audio amplification circuit comprise a comparator operatively coupled to one of the first and second preamplifiers and operable to detect a zero crossing of the corresponding first or second amplified audio signal, and to provide to the signal selection circuit a detection signal indicative of a detected zero crossing; and wherein the signal selection circuit is operable to use the detection signal to control the switch to switch between conveying the first or second amplified audio signal to the analogue-to-digital converter.

A zero-crossing of a signal may be detected in a number of ways. For example, a zero-crossing may be detected by a change of sign of the signal. Alternatively or additionally, the detection of a zero crossing may comprise the detection of a signal level having a value in a predetermined threshold proximity of zero, e.g. below a predetermined noise floor level. Hence, the term “detected zero-crossing” is intended to include a detected signal level within a predetermined threshold proximity of zero.

By effecting the signal switching at a detected zero-crossing of the first and/or the second digital audio signal audible artefacts such as “clicks”, “pops” or other objectionable artefacts in connection therewith are eliminated or at least considerably suppressed. Switching at the detected zero-crossings of the first and/or the second digital audio signal(s) minimizes error energy in a waveform of an outgoing digital audio signal the controller output by suppressing waveform discontinuities at a signal switch point.

In a preferred embodiment, the switching between the first and second digital audio signals is exclusively effected at a detected substantially simultaneous zero-crossing of the first and second digital audio signals. Accordingly, some embodiments of the audio amplification circuit comprise a first comparator operatively coupled to the first preamplifier and operable to detect a zero crossing of the first amplified audio signal, and to provide to the signal selection circuit a first detection signal indicative of a detected zero crossing; a second comparator operatively coupled to the second preamplifier and operable to detect a zero crossing of the second amplified audio signal, and to provide to the signal selection circuit a second detection signal indicative of a detected zero crossing; and wherein the signal selection circuit is operable to use the first and second detection signals to control the switch to switch between conveying the first or second amplified audio signal to the analogue-to-digital converter. The signal selection circuit may thus be operable to detect a substantially simultaneous zero-crossing of the first and second amplified audio signals and to control the switch to switch between conveying the first or second amplified audio signal to the analogue-to-digital converter at the detected substantially simultaneous zero-crossing of the first and second amplified audio signals.

In the present context, the term “a detected substantially simultaneous zero-crossing” designates a detected zero-crossing of the first amplified audio signal and a detected zero-crossing of the second amplified audio signal taking place within a window of 10 or less sample time intervals such as less than 3 sample time intervals of the resulting digital audio signal. The duration of a sample time interval may be determined by a Nyquist sampling frequency of the digital audio signal which preferably lies between 8 kHz and 48 kHz such as between 16 kHz and 48 kHz. This embodiment has the advantage that the switching of the output state of the signal selection circuit is dynamically controlled and may take non-linear behaviour of transfer functions of one or both of the first and second signal channels of the audio amplification circuit into account. The present inventors have experimentally verified that an input impedance at the input terminal of the audio amplification circuit may behave non-linearly at very high or large levels of the audio input signal and modulate the transfer functions of one or both of the first and second signal channels. This modulation of the transfer function or functions tend to impair an otherwise (for small signal operation) well-matched phase relationship between the first and second amplified audio signals. In accordance with the present embodiment, the signal selection circuit is adapted to solely to change output state in response to detected substantially simultaneous zero-crossings of the first and second amplified audio signals. In this manner, a detected zero-crossing in only one of the first and second amplified audio signals is ignored and the signal selection circuit retains its current output state by continuing to convey the first or second amplified audio signal, as the case may be, to the analogue-to-digital converter.

Alternatively or additionally, some embodiments of the audio amplification circuit comprise a comparator operatively coupled to the first and the second preamplifier and operable to provide to the signal selection circuit a detection signal indicative of a comparison of the first and second amplified audio signals; and wherein the signal selection circuit is operable to use the detection signal to control the switch to switch between conveying the first or second amplified audio signal to the analogue-to-digital converter.

In some embodiments, the audio amplification circuit comprises a signal feature estimation circuit adapted to estimate a signal feature of at least one of the first amplified audio signal, the second amplified audio signal, and the digital audio signal, and to compare the estimated signal feature with a predetermined feature criterion; and wherein the signal selection circuit is adapted to control the switch to switch between conveying the first or second amplified audio signal to the analogue-to-digital converter based on the comparison between the estimated signal feature and the predetermined feature criterion.

The outcome of the comparison between the estimated signal feature and the predetermined feature criterion may determine at which detected zero-crossings a switch from providing first amplified audio signal to the analogue-to-digital converter to providing the second amplified audio signal to the analogue-to-digital converter, or vice versa, is to be made. The signal selection circuit may be adapted to detect various types of predetermined signal features of the digital audio signal such as a level of the digital audio signal, a non-linear distortion of the digital audio signal, a DC level of the digital audio signal, a noise level of the digital audio signal or, a spectral feature of the digital audio signal or any combinations of these signal features. In one embodiment of the invention, the predetermined signal feature is the level of the digital audio signal or a level of the first or second amplified audio signal or a combination thereof.

One useful signal feature is the level of the digital audio signal, which is computable or detectable with good precision and reliability in a relatively straight-forward manner. The level may be estimated in various ways in either time domain or frequency domain or a combination of both. The level of the digital audio signal may be estimated as running average amplitude or power of the digital audio signal. The running average amplitude or power may comprise a simple half-wave or full-wave rectified average amplitude, a RMS average amplitude or power, a short-term average amplitude or power, a short-term RMS amplitude or power.

The running average amplitude or power may be determined over a time window with a length between 0.1 millisecond and 200 milliseconds wherein a corresponding number of samples of the digital audio signal are summed. Naturally, samples within the chosen time window may be multiplied by a suitable weight function such as a triangular function or exponential function.

A detected level can, by comparison with one or more predetermined threshold levels (i.e. predetermined feature criterion), be used to indicate how far the digital audio signal is from its overload limit. In one embodiment the predetermined threshold level may be set to a value somewhat below the lower one of an overload limit of the first preamplifier and an overload limit of the analogue-to-digital converter such as between 1 and 6 dB below the overload limit in question. In some embodiments, e.g. in microphone signal applications of the present audio amplification circuit, the predetermined feature criterion, for example comprising a certain threshold level, may be set to a value which corresponds to a target or desired sound pressure level on a microphone transducer element at a reference frequency. The target sound pressure level may be set to a value between 100 dB SPL and 130 dB SPL for a number of useful mobile terminal applications of the present audio amplification circuit. In this way, when the switch is controlled to forward the first amplified audio signal to the analogue-to-digital converter, the resulting digital audio signal may represent small and normal (human speech produces around 65-70 dB SPL average measured at 1 meter distance) sound pressure levels for example within a range from 0 to 100 dB SPL. Similarly, when the estimated level exceeds the predetermined threshold level and the switch is controlled to forward the second amplified audio signal instead of the first amplified audio signal to the analogue-to-digital converter, the resulting digital audio signal may represent very large sound pressure levels above 100 dB SPL. When the estimated level subsequently drops to a level below the predetermined threshold level, e.g. 100 dB SPL, the signal selection circuit switches from conveying the second to conveying the first amplified audio signal to the analogue-to-digital converter. This switching between, or swapping of, the first and second analogue audio signals may be effected with a certain preset or adaptive time constant as described below.

In some embodiments, the signal selection circuit is adapted to execute steps of:
estimating the level of the digital audio signal with a first time constant for increasing absolute values of audio signal samples of the digital audio signal,
estimating the level of the digital audio signal with a second time constant for decreasing absolute values of audio signal samples of the digital audio signal; the second time constant being larger than the first time constant.

The different time constants can be used to set different attack and release times for switching between conveying the first or second amplified audio signal to the analogue-to-digital converter. A relatively short attack time, e.g. smaller than 2 ms, such as between 20 μs and 200 μs may be set for the increasing of absolute values of audio signal samples of the digital audio signal. The first time constant may in one extreme be set to a value that corresponds to a single sample time interval of the digital audio signal so as to provide a peak-tracking level estimate. A relatively short attack time ensures that the signal selection circuit reacts rapidly once the estimated level exceeds the predetermined threshold level and switches output states, e.g. as soon as a zero-crossing is detected, so as to convey the second amplified audio signal instead of the first amplified audio signal to the analogue-to-digital converter. The rapid reaction to signal levels exceeding the predetermined threshold level ensures that clipping or overload distortion of the first amplified audio signal is effectively suppressed in the outgoing digital audio signal provided at the output of the audio amplification circuit. A relatively long release time, such as between 1 ms and 200 ms, or between 1 ms and 40 ms, tend to suppress rapid switching back and forth between conveying the first or second amplified audio signal to the analogue-to-digital converter under signal conditions where the level of the digital audio signal that is detected is fluctuating rapidly just above and below the predetermined threshold level. Furthermore, when the first and second amplified audio signals are derived from, or representative of, the common audio input signal with first and second signal amplifications, respectively, in the manner described above, the relatively large value of the second time constant or the release time may provide significant benefits in numerous situations because the long release time allows the circuitry of the first signal channel, in particular the first preamplifier, to recover theirs/its nominal operating points before the first amplified audio signal is transmitted to the analogue-to-digital converter. The circuitry of the first signal channel of the audio amplification circuit may have been forced into a highly non-linear operating state during a preceding time period with a very high level of the audio input signal. It may accordingly take significant time before this circuitry is settled to its nominal operating point and capable of low-distortion signal amplification.

A practical manner of providing first and second level estimates of the digital audio signal comprises adapting the signal selection circuit to execute steps of:

a)—initializing a peak tracking variable, MaxPeak, representing a maximum absolute value of the digital audio signal between a pair of consecutive detected zero-crossings of a selected one of the first and second amplified audio signals, to an initial value,
b)—comparing an absolute value of a current audio signal sample, ABS x(n), of the digital audio signal with a current level estimate, Yp(n−1),
c)—computing an updated level estimate, Yp(n), with the first time constant if the absolute value of the current audio signal sample is larger than the current level estimate, Yp(n−1),
d)—computing the updated level estimate, Yp(n), with the second time constant if the absolute value of the current audio signal sample is smaller than the current level estimate, Yp(n−1),
d)—comparing the value of the peak tracking variable, Maxpeak, with the updated level estimate, Yp(n),
e)—if the updated level estimate, Yp(n), is larger than the peak tracking variable, MaxPeak, updating the value of MaxPeak to Yp(n),
f)—if the updated level estimate, Yp(n), is smaller than the peak tracking variable, MaxPeak, retaining a current value of MaxPeak,
g)—detecting a zero-crossing of the selected one of the first and second amplified audio signals,
h)—when a zero-crossing is detected, compare the value of MaxPeak to a first predetermined threshold level,
i)—if the value of MaxPeak is larger than the first predetermined threshold level: switch to transmitting the second amplified audio signal to the analogue-to-digital converter or continue transmitting the second amplified audio signal to the analogue-to-digital converter,
j)—if the value of MaxPeak is smaller than the first predetermined threshold level: switch to transmitting the first amplified audio signal to the analogue-to-digital converter or continue transmitting the first amplified audio signal to the analogue-to-digital converter.

In this embodiment, the first or the second amplified audio signal is monitored for the presence of a zero-crossing. A zero-crossing may conveniently be indicated based on the output signal from a comparator operationally coupled to the output of one of the first and second preamplifiers and to a reference, e.g. a clocked comparator. A detected zero crossing may e.g. be indicated in the signal selection circuit by setting a flag or similar indicator in a dedicated memory location or register of the signal selection circuit. In some embodiments, the flag may be set when the comparator detects a change in sign of the first or the second amplified audio signal, respectively. In some embodiments, the flag may be set when the comparator detects that the signal level is below a predetermined threshold, e.g. below a predetermined noise floor or another suitable threshold level e.g. a threshold level above the noise floor. If no zero-crossing has been detected, the signal selection circuit may retain its current output state by continuing to cause the switch to transmit a current amplified audio signal to the analogue-to-digital converter and continuing to monitor the first and/or the second amplified audio signal for a zero-crossing. On the other hand, once a zero-crossing has been detected the signal selection circuit proceeds by executing steps i) and j) as stated depending upon an outcome of the comparison between the value of MaxPeak and the first predetermined threshold level. A change or switch of output state of the signal selection circuit during execution of step i) may be effected if the current output state transmits the first amplified audio signal to the analogue-to-digital converter. Likewise, a change of output state of the signal selection circuit during execution of step j) may be effected if the current output state transmits the second amplified audio signal to the analogue-to-digital converter. In any event, when a zero-crossing has been detected, the value of MaxPeak is reset to an initial value.

In some embodiments, the audio amplification circuit may comprise a first comparator operationally connected to the first preamplifier and adapted to compare the first amplified audio signal with a predetermined threshold representing a zero level (e.g. a threshold indicative of a predetermined noise floor), and a second comparator operationally connected to the second preamplifier and adapted to compare the second amplified audio signal with a corresponding predetermined threshold. The signal selection circuit may determine a current one of the first and second amplified signals that is currently transmitted to the analogue-to-digital converter, and may detect a zero-crossing of the current amplified audio signal based on an output of the corresponding comparator.

In a further refined embodiment, two different predetermined threshold levels are utilized to provide additional hysteresis in the switching between output states of the signal selection circuit. The two different predetermined threshold levels may be spaced with an amount of 3 to 10 dB in level. The signal selection circuit is adapted to execute further steps after step i) of:

i1)—comparing the value of MaxPeak to a second predetermined threshold level smaller than the first predetermined threshold level with a predetermined amount,
i2)—if the value of MaxPeak lies between the second predetermined threshold level and the first predetermined threshold level: continue transmitting a current one of the first or the second amplified audio signal to the analogue-to-digital converter,
i3)—if the value of MaxPeak is smaller than the second predetermined threshold level: transmitting the first amplified audio signal to the analogue-to-digital converter.

In another embodiment, the signal feature comprises a DC level of the digital audio signal. Yet another useful signal feature may be a shape of frequency spectrum of the digital audio signal where significant overload of the first signal channel may be detected by the signal selection circuit by identifying a skewed frequency spectrum of the digital audio signal caused by preamplifier clipping and/or A/D converter overload while the first amplified audio signal is transmitted to the A/D converter.

In embodiments of the audio amplification circuit where the first and second amplified audio signals are derived from the common audio input signal with first and second signal amplifications, respectively, in the manner described above, the present audio amplification circuit accomplishes transmitting an essentially noise free digital audio signal to the output of the audio amplification circuit at low and normal levels of the audio input signal in form of the digital audio signal originating from the first amplified audio signal. Additionally, the present audio amplification circuit may also provide an undistorted digital audio signal to the output of the audio amplification circuit at high and extremely high levels of the audio input signal by selectively transmitting (by an appropriate setting of the predetermined feature criterion) the second amplified audio signal to the analogue-to-digital converter and transmitting the resulting a digital audio signal to the output of the audio amplification circuit.

When the first and second amplified audio signals are derived from the common audio input signal with first and second signal amplifications, respectively, in the manner described above, the output of the audio amplifier circuit accordingly toggles between two different output states in form of a low sensitivity or amplification state where the second amplified audio signal is transmitted to the analogue-to-digital converter and the resulting digital audio signal is transmitted to the output of the audio amplification circuit, and a normal sensitivity state where the first amplified audio signal is transmitted to the analogue-to-digital converter instead, and the resulting digital audio signal is transmitted to the output of the audio amplification circuit. Even though the input referred noise floor may be elevated during time intervals wherein the second amplified audio signal is transmitted due to the lower signal amplification of the second channel, this effect can be effectively masked to the human auditory system by a simultaneous high level of the audio input signal. The auditory masking of the elevated input referred noise floor can be improved if appropriate time constants in form of attack and release times are chosen for switching output states at the controller output as described below.

Preferably, switching from conveying the first amplified audio signal to the second amplified audio signal, or vice versa, to the analogue-to-digital converter is effected without any summing, blending or mixing of the first and second amplified audio signals prior to selecting one of these. The selective transmission of either the first or second amplified signal minimizes computational and hardware resource expenditure of the audio amplification circuit since signal selection can be effected by providing appropriate control signals to a simple multiplexer switch, e.g. a 2-1 switch, (or a 3-1, 4-1 etc multiplexers if three, four or more separate signal channels are provided). In this way, the outgoing digital audio signal transmitted at the output of the audio amplification circuit essentially forms a single stream of digital audio samples comprising intermittently arranged and abutted segments of audio signals selectively originating from the first and second amplified audio signals, selected in accordance with outcomes of the comparisons between the estimated signal feature and the predetermined feature criterion.

Preferably, the signal selection circuit is adapted to switch output state in less than 1 ms, more preferably less than 625 μs, or even more preferably less than 208 μs such as less than 62.5 μs, within a detected zero-crossing of the first or the second amplified audio signal. These time intervals may correspond to a single or a few sample time intervals of the corresponding digital audio signal, such as within 10 sample time intervals of the digital audio signal when it is provided at its reduced or Nyquist sampling frequency. The Nyquist sampling frequency of the digital audio signal may conveniently lie between 16 kHz and 48 kHz so that a sample time interval between samples of the digital audio signal lies between 20.8 and 62.5 μs to comply with standardized or at least often used sampling frequencies of digital audio systems. A rapid switching after or before a detected zero-crossing ensures that the first and/or second amplified audio signals still has/have an instantaneous amplitude reasonably close to zero to ensure minimum “click” sounds. Actual signal deviation from zero will depend on a slew rate of the first or second amplified audio signals at the detected zero-crossing.

Some embodiments of the present audio amplification circuit are adapted to, before the step of estimating the signal feature of the digital audio signal, execute step of filtering the digital audio signal by a digital DC blocking filter. The digital DC blocking filter may comprise a digital high-pass filter having a high-pass cut-off frequency lower than 30 Hz, preferably lower than 15 Hz to allow the signal feature estimation to accurately detect or reflect peak amplitudes of large low-frequency or infrasonic signals imparted on the analogue signal processing and amplification circuit of the audio amplification circuit. The digital DC blocking filter is operative to eliminate DC voltage variations in the digital audio signal resulting from the first and second amplified audio signals. Such DC voltage differences may have been introduced by mismatched DC bias settings of analogue signal processing and amplification circuits of the respective first and second analogue signal paths.

The signal selection circuit and/or the level detector and/or the digital scaling function may be implemented by a suitable digital audio signal circuit implemented as fixed or hard-wired application-specific circuit blocks with appropriately configured digital arithmetic and logic units. Alternatively or additionally, the signal selection circuit and/or the level detector and/or the digital scaling function may comprise a programmable microprocessor such as a programmable fixed-point or programmable floating-point Digital Signal Processor.

In accordance with a favourable embodiment or aspect, a semiconductor die or substrate comprises an audio amplification circuit according to any of the embodiments of the audio amplification circuit disclosed herein. The integrated semiconductor die is preferably fabricated in a sub-micron CMOS semiconductor process to allow large scale manufacturing of the audio signal amplification circuit at very low costs.

Another aspect of the invention relates to a miniature capacitive microphone which comprises a capacitive transducer element responsive to impinging sound to generate a corresponding transducer signal on a transducer signal terminal. According to this aspect the input pad or terminal of an integrated semiconductor circuit in accordance with any of the embodiments of this circuit described herein is operatively coupled to the transducer signal terminal for receipt of the transducer signal. The miniature capacitive microphone may be formed by an ECM or a microelectromechanical (MEMS) condenser microphone shaped and sized for mobile terminal applications.

Yet another aspect of the invention relates to a method of amplifying audio signals, the method comprising:
applying an analogue audio input signal received at an input terminal of an amplification circuit to an input of a first preamplifier,
generating a first amplified output signal by the first preamplifier having a first signal amplification,
applying an analogue audio input signal received at an input terminal of an amplification circuit to an input of a second preamplifier,
generating a second amplified audio signal by second preamplifier having a second signal amplification; wherein the second signal amplification is smaller than the first signal amplification, preferably with a value or amount of at least 10 dB throughout a frequency range between 300 Hz and 3 kHz;
selecting one of the first and second amplified audio signals;
converting the selected one of the first and second amplified output signals to a digital audio signal.

The method of amplifying audio signals may further comprise steps of:
attenuating the analogue audio input signal with a predetermined amount or factor,
applying the attenuated analogue audio input signal to an input of the second preamplifier.

The present method of amplifying audio signals may comprise an additional step of clamping the analogue audio input signal at a first limiting level by a cascade of two or more non-linear elements, such as diodes or diode-coupled transistors, operatively coupled between the input terminal and at least one of {a DC power supply rail, a DC reference voltage}.

In some embodiments, the method comprises steps of:
estimating a signal feature of the digital audio signal
comparing the estimated signal feature with a predetermined feature criterion,
switching from selecting the first amplified audio signal to selecting the second amplified audio signal, or vice versa, based on the comparison between the estimated signal feature and the predetermined feature criterion.

In some embodiments, switching comprises switching from selecting the first amplified audio signal to selecting the second amplified audio signal, or vice versa, at a detected zero-crossing of at least one of the first and second amplified audio signals.

The method may advantageously comprise further steps of:
monitoring the first and second amplified audio signals and detecting respective zero-crossing of the first and the second amplified audio signals,
detecting a substantially simultaneous zero-crossing of the first and second amplified audio signals,
switching from selecting the first amplified audio signal to selecting the second amplified audio signal, or vice versa, at the detected substantially simultaneous zero-crossing of the first and second amplified audio signals.

### BRIEF DESCRIPTION OF THE DRAWINGS

Embodiments of the invention will be described in more detail in connection with the append drawings in which:

FIG. 1 is a schematic drawing of an audio amplification system comprising an embodiment of an audio amplification circuit as described herein.

FIG. 2 is a schematic drawing of another embodiment of an audio amplification circuit.

FIG. 3 is a more detailed diagram of a zero crossing detection circuit for an audio amplification circuit,

FIG. 4 is a flow-chart illustrating program or process steps executed by an embodiment of the signal selection circuit of an audio amplification circuit described herein.

### DESCRIPTION OF PREFERRED EMBODIMENTS

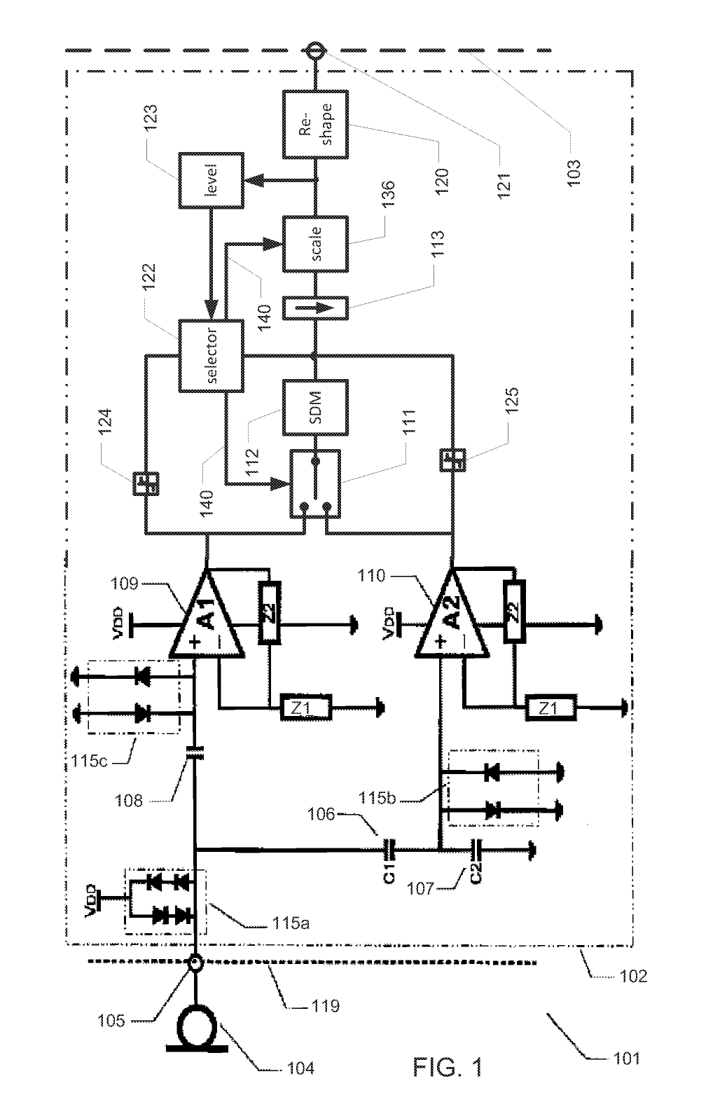

FIG. 1 is a schematic drawing of an audio amplification circuit system 101 which comprises a microphone and 104 an audio amplification circuit 102 according to a first embodiment. The audio amplification circuit may serve as a front-end of a subsequent audio signal processing circuit (not shown). As illustrated by dashed interface line 103, the audio amplification circuit 102 may either be fabricated or implemented on separate CMOS semiconductor die or it may be fabricated on a common CMOS semiconductor die together with a subsequent signal processing circuit. A separate audio signal processing circuit may reside remotely for example within a portable terminal in form of an appropriately programmed or configured Digital Signal Processor (DSP) with data interface terminal(s) operatively coupled to the illustrated externally accessible output terminal 121 of the present audio amplification circuit 102 for receipt of a digital audio signal or digital audio stream. In this configuration, the audio amplification circuit 102 may reside on a printed circuit board or other carrier of the portable terminal or alternatively be mounted within a miniature microphone housing of a microphone of the portable terminal.

The audio amplification circuit 102 may be shaped and sized for integration into a miniature microphone housing. In the illustrated embodiment, the audio amplification circuit 102 is connected to a miniature capacitive microphone 104 through an input terminal or pad 105 of the amplification circuit 102 via conventional wire bonding techniques. It will be appreciated that the audio amplification circuit 102 may be connected to and optionally sized and shaped for integration of a housing of a variety of different types of microphones, e.g. different types of miniature capacitive microphones. The amplification circuit 102 comprises first and second preamplifiers 109, 110, respectively, which in this embodiment are implemented as non-inverting operational amplifiers, each having an audio frequency amplification controlled by the impedance ratio of two impedances Z1 and Z2. The impedances Z1 and Z2 may comprise respective resistors or capacitors setting the respective audio band voltage gains of the first and second preamplifiers 109, 110, respectively.

The first and second preamplifiers 109, 110, respectively, form part of an upper and lower signal path or channel operatively coupled to a common analogue audio input signal through input terminal 105. The upper signal path comprises a DC blocking filter formed by capacitor 108 operating to remove DC components from the input audio signal before being applied to a non-inverting input of the first preamplifier 109 (A1). In this embodiment the capacitance of the DC blocking capacitor 108 is preferably between 1 and 20 pF, more preferably about 2 pF. The lower signal path comprises two capacitors C1 106 and C2 107, coupled as a capacitive voltage divider of the audio input signal. The function of the voltage divider, is to attenuate the audio input signal to the preamplifier A2 110 of the lower signal path, by a factor given by V_{audio}=V_{mic} C₁/(C₂+C₁) where V_{audio} is the audio input signal to the preamplifier 110 of the lower signal path and V_{mic} is the audio input signal generated by a microphone transducer element of the miniature microphone 104. A capacitive voltage divider comprising C1 106 and C2 107 is accordingly connected in-between the input terminal 105 and the non-inverting input of the second preamplifier 110. Sizes of the capacitances C1 and C2 are generally adapted to a generator impedance of the audio source supplying audio input signals through the input terminal 105. In the present embodiment, where the audio source is a miniature microphone 104, the value of C1 is preferably in a range between 20 and 100 fF (1 fF=10⁻¹⁵ F). Preferably C2 is 2-20 times larger than C1, more preferably about 9 times larger, resulting in approximately 20 dB of signal attenuation of the input signal to the second preamplifier 110. A first pair of anti-parallel bias diodes 115c is coupled between a non-inverting input terminal of the first preamplifier 109 and GND to set an appropriate DC bias point of the first preamplifier 109. The pair of anti-parallel bias diodes 115c functions as an extremely high impedance bias circuit with an impedance of 10 GΩ or larger for small signal operation of the first preamplifier 109. The extremely high impedance minimizes loading on the signal input terminal 105 and therefore maximizes the level of the audio input signal delivered by the microphone transducer element. In addition the pair of anti-parallel bias diodes 115c functions as overload protection or signal limiting for the non-inverting input terminal of the first preamplifier A1 by limiting a peak signal input voltage to about +/−0.5 Volt which corresponds to one diode voltage drop over a single forward diode of the pair of anti-parallel bias diodes 115c. A similar pair of anti-parallel bias diodes is coupled between a non-inverting input terminal of the second preamplifier 110 and GND as well. Finally a third set of anti-parallel diodes 115a is coupled between the input terminal 105 of the audio amplification system and a positive DC power supply voltage or rail V_{DD}. Each leg of the third set of anti-parallel diodes 115a comprises a cascade of two, or optionally more, diodes and operates to limit a peak signal input voltage to the audio amplification system to about +/−1.0 Volt (or higher if more diodes are cascaded in each leg) which corresponds to two diode voltage drops across forward-conducing diodes.

The upper, or normal sensitivity signal path, and lower, or low sensitivity signal path, each are connected to respective inputs of a switch 111 operated as a 2-1 multiplexer and adapted to selectively provide either the output signal of the first preamplifier 109 or the output of the second preamplifier at the output of switch 111. The switch 111 is controlled by a selector signal 140 indicating whether the amplified audio signal from preamplifier 109 or from preamplifier 110 should be selected. The output of switch 111 is connected to a sigma-delta analogue-to-digital converter 112 for converting the selected analogue output signal provided at the output of either the first or the second preamplifier 109, 110 into a digital audio signal. The digital audio signal is transmitted to a decimation filter 113. In one embodiment, the sigma-delta analogue-to-digital converter 112 is a single-bit converter operating at an oversampled sampling rate or frequency of 2.4 MHz. In the present embodiment, the decimation filter receives a one-bit digital audio stream at the oversampled sampling rate of 2.4 MHz and down-samples this single-bit audio stream to form a decimated and lowpass filtered digital audio signal with a word length of 16 bits at a 48 kHz reduced sampling frequency. However the skilled person will understand that a wide range of oversampled sampling frequencies, such as between 1.0 MHz and 10 MHz, and reduced sampling frequencies such as between 8 kHz and 96 kHz may be used by suitable adaptation of the illustrated embodiment in accordance with requirements of a particular application.

The decimated and lowpass filtered digital audio signal is transmitted to a gain scaling block 136. The gain scaling block 136 is adapted to apply, responsive to the selector signal 140, a gain scaling operation or step to the digital audio signal. For example, the gain scaling block may comprise a multiplier controlled by the selector signal 140. The multiplier may thus multiply the digital audio signal with a scaling factor provided as a preset value by the gain scaling block when the selector signal 140 indicates that the signal from preamplifier 109 is currently selected. As previously explained, in one embodiment, the audio input signal may have been attenuated by approximately 20 dB by the capacitive voltage divider formed by C1 and C2 (as shown in FIG. 1) coupled to the audio input signal. The scaling factor may thus conveniently be set to a value of 0.1 in the present case to compensate for the amplification difference between the first and second signal amplifications of the amplification circuit. Conversely, when the selector signal 140 indicates that the signal from preamplifier 110 is currently selected, the gain scaling block does not perform any scaling (or a scaling with a scaling factor of 1). The selector signal 140 may be fed through a suitably chosen delay in order to compensate for the delay introduced by the sigma-delta modulator 112 and the filter 113 so as to cause any change in gain scaling to be suitably synchronised with a corresponding change in the selection of the first or second amplified audio signal by switch 111.

The digital audio signal with appropriately equalized level is thereafter transmitted to a digital audio interface configured to receive and convert the digital audio signal at the 16 kHz reduced or Nyquist sampling rate into a digital audio stream compliant with a standardized data communication/digital audio protocol such as I²S, S/PDIF, AES/EBU, SLIMbus™. In some embodiments the digital audio interface 120 is configured to output a standardized N-bit format (N typically being a positive integer, e.g. N=1)

The audio amplification circuit 102 comprises a signal selection circuit 122 comprising logic and arithmetic circuitry configured for generating the signal selection signal 140 for selectively controlling the switch 111 to convey or transmit one of the first and second amplified audio signals based on a level, or other signal feature(s), of the digital audio signal. In the present embodiment, the signal selection circuit 122 receives input from a level estimator 123 and from a first and a second zero-cross detector 124 and 125, respectively.

The first and second zero-cross detectors 124, 125 are adapted to monitor the first and second amplified audio signals, respectively, for zero-crossing.

The signal selection circuit 122 uses detected simultaneous zero-crossings of the first and second amplified audio signals to control the switch 111 to switch between conveying the first or the second amplified audio signal to the sigma-delta modulator 112, if certain other criteria regarding the level of the digital audio signal are met as described below.

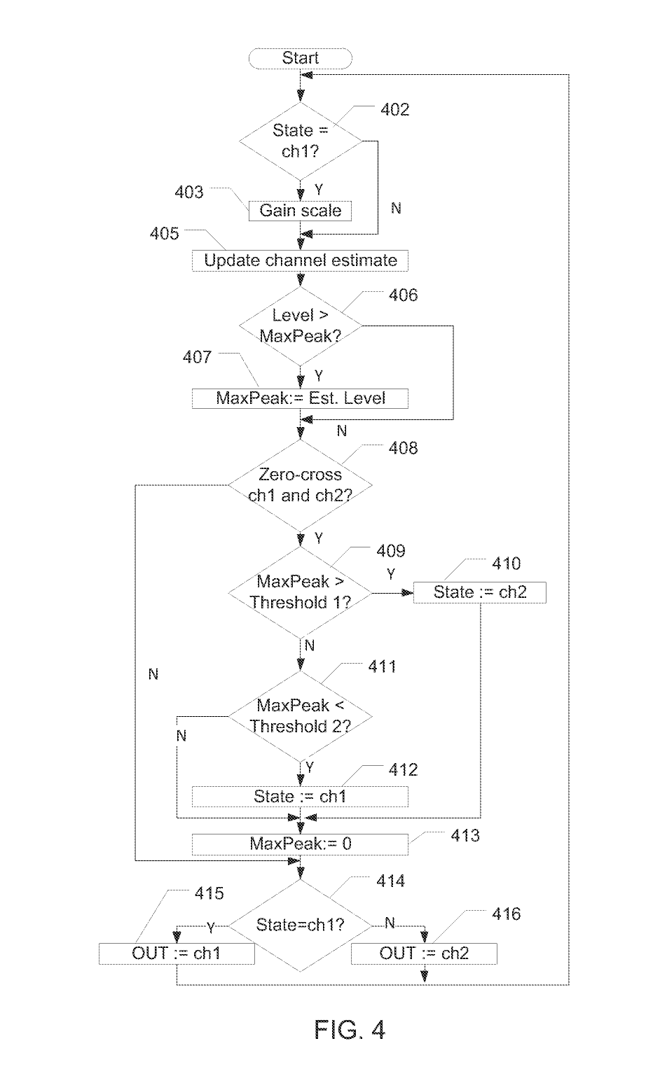

A level estimator 123 is adapted to detect a pair of level estimates of the digital audio signal and transmit these to the signal selection circuit 122. A first level estimate is detected as running absolute peak amplitudes of the digital audio signal for increasing levels of the digital audio signal. A second level estimate is computed or detected with a larger time constant as a running average level provided by averaging about 100 samples of the digital audio signal corresponding to an averaging time of about 6.25 ms at the 16 kHz sampling frequency. The signal selection circuit 122 is configured to read or determine the first and second level estimates on a running basis and compare these with a predetermined threshold level, or optionally with one of two different threshold levels, to determine which of the first and second amplified audio signals that is to be conveyed to the sigma-delta modulator 112. The predetermined threshold level is set to a signal level which corresponds to approximately 3 dB below, such as between 2 and 6 dB below, the overload limit or level of the first signal channel to ensure the signal selector 122 can switch state and cause transmission the second instead of the first amplified audio signal before the first channel reaches its overload limit or level or at least shortly thereafter. The level estimation function or step and signal selection process is explained in additional detail below in connection with the description of the flowchart on FIG. 4.

The audio amplification system 101 is powered from the positive DC power supply voltage or rail through supply terminal V_{DD}. GND level acts as a negative DC power supply voltage or rail for the audio amplification system 101. In one embodiment, the audio amplification system 101 is designed for operation on DC power supply voltages between 1.2 Volt and 2.0 Volt such as about 1.8 Volt. The audio amplification system 101 preferably comprises a clock input terminal (not shown) for receipt of, and synchronization to, an externally generated system clock to allow the digital audio signals transmitted from the output 121 to be synchronized to the externally generated system clock.

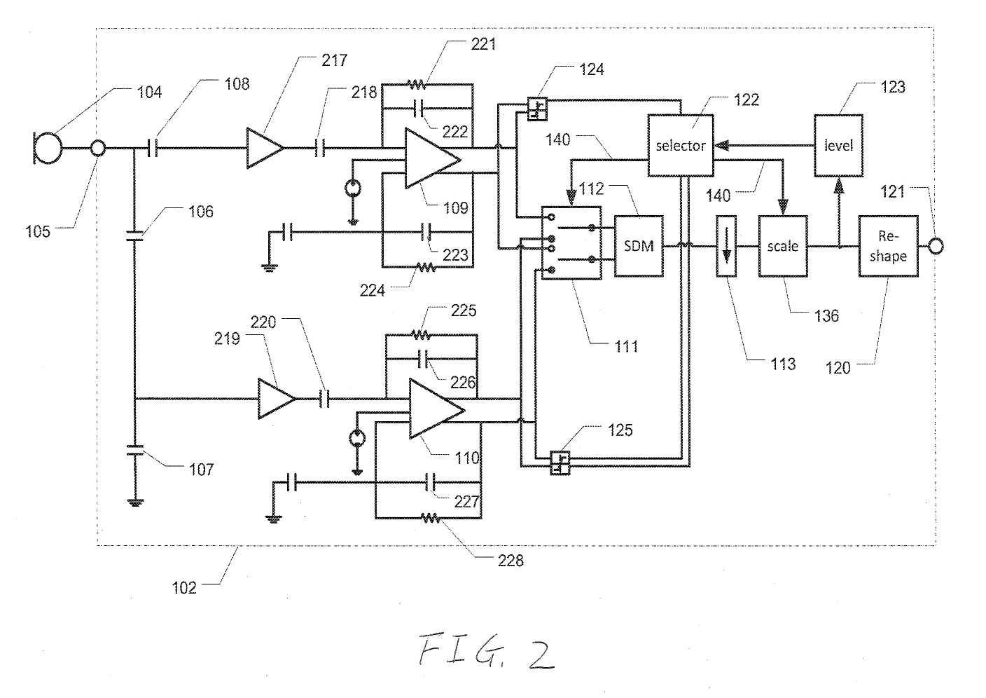

FIG. 2 is a schematic drawing of an audio amplification circuit 102 according to another embodiment of the invention. Corresponding features in the first and second embodiments of the audio amplification circuits may have identical electrical characteristics, such as capacitance, resistance, amplification etc, and have been provided with the same reference numerals to ease comparison. Corresponding features will not be described in detail again.

The audio amplification circuit 102 comprises first and second preamplifiers 109, 110, respectively. The first and second preamplifiers 109, 110, respectively, form part of an upper and lower signal path or channel operatively coupled to a common analogue audio input signal through input terminal 105, all as described in connection with the first embodiment. Each preamplifier comprises a differential amplifier and respective feed-back structures comprising respective capacitors 222, 223, 226, 227 and resistors 221, 224, 225, 228. The differential output of the preamplifiers is fed to respective inputs of switch 111 which is operated as a multiplexer transmitting its output to the differential sigma-delta modulator 112.

Each signal path comprises a source follower 217 and 219, respectively, and a further capacitor 218 and 220, respectively. The lower signal path comprises two capacitors 106 and 107, coupled as a capacitive voltage divider of the audio input signal applied to the input terminal 105. The function of the voltage divider is to attenuate the audio input signal to the preamplifier 110 of the lower signal path, by the factor outlined above.

The signal selection circuit comprising zero crossing detectors 124 and 125, decimation filter 113, gain scaling block 136, level detector 123, and signal selection circuit 122 are operable as described in connection with the first embodiment.

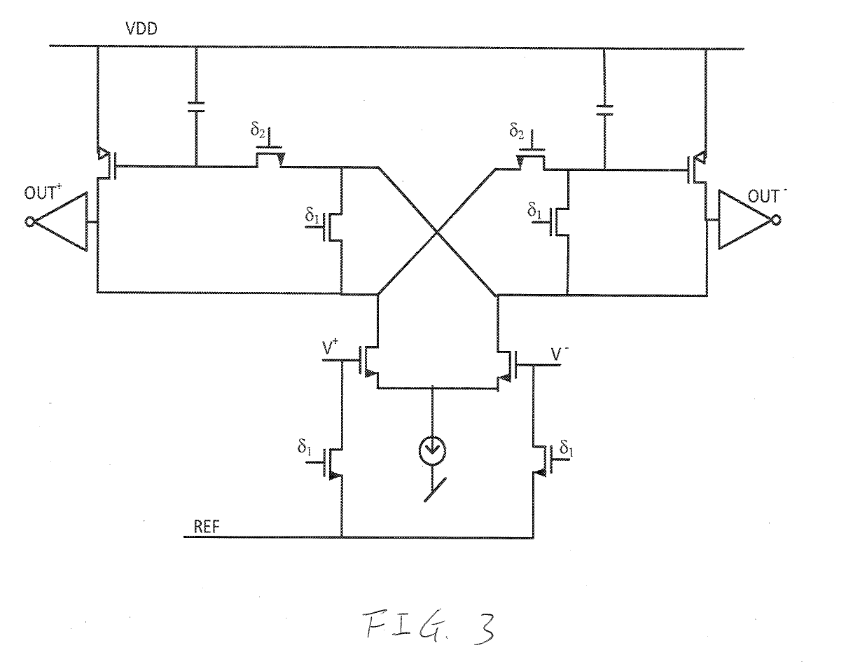

It will be appreciated that a zero-crossing may be determined in variety of ways for each of the first and second amplified audio signals, e.g. by a clocked comparator. FIG. 3 is a detailed block diagram of an example of a comparator circuit for detecting a zero crossing, e.g. of one of the comparators 124 and 125 of the embodiment of FIG. 2. The comparator 124 of FIG. 3 is a dynamic differential comparator controlled by signals δ₁ and δ₂. It receives a differential input V⁺ and V⁻ and provides a corresponding differential output OUT⁺ and OUT⁻ indicative of. It will be appreciated that, in embodiments where the sigma-delta converter is a switched capacitors type of sigma-delta modulator, the comparators may be switched comparators synchronized to the clock phases of the sigma-delta modulator.

Even though not explicitly shown in FIG. 2, it will be appreciated that the audio amplification circuit may comprise additional or alternative components, e.g. one or more suitably connected pairs of anti-parallel bias diodes to set an appropriate DC bias point of the first and/or second preamplifier. Furthermore, even though the amplification circuits shown in FIGS. 1 and 2 comprise two zero-crossing detectors thus allowing detection of substantially simultaneous zero-crossings of the first and second amplified signal channels, it will be appreciated that alternative embodiments may employ alternative circuitry for detecting zero crossings. For example, in one embodiment, the signal amplification circuit may comprise a single zero-crossing detector operable to detect a zero-crossing in the first or the second amplified audio signal only. In such an embodiment, switching between the first and second signal channel may be performed responsive by a detection of a zero-crossing in only one of the signal channel. In yet an alternative embodiment, the audio amplification circuit may comprise a comparator operatively connected to the first and second preamplifiers and adapted to compare the first and second amplified signals with each other. In such an embodiment, switching between the first and second signal channel may be performed responsive to both amplified signals being substantially equal.

FIG. 4 shows process steps executed by a signal selection circuit, e.g. signal selection circuit 122 of FIGS. 1 and 2. At initial step 402, a current setting of a state variable “State” is read. The state variable “State” indicates whether the first amplified audio signal supplied by the upper channel (ch1) or the second amplified audio signal supplied be the lower channel (ch2) is to be transmitted to the sigma-delta converter. If the current setting of the state variable “State” is “ch1”, the process proceeds at step 403; otherwise the process skips process step 403 and proceeds to step 405 instead. At step 403 the digital audio signal is multiplied with the previously described scaling factor to align audio signal levels of the first and second amplified audio signals in the corresponding signal channels.

At step 405 one of two different updated level estimates, Yp(n), is computed. The two level estimates are derived from the digital audio signal with different time constants by the signal selection circuit 122 depending on whether the absolute amplitude of samples of the digital audio signal is increasing or decreasing in level according to the level computing algorithm or equation below:

Xp(n)=ABS(x(n));

if Xp(n)>Yp(n−1)

Yp(n)=(1−A)*Xp(n)+A*Yp(n−1);

else

Yp(n)=(1−B)*Xp(n)+B*Yp(n−1);

end;

Here, x(n) denotes the input to the level estimator, Yp(n−1) is a current level estimate at an output of the level estimator, Yp(n) is an updated level estimate at an output of the level estimator, A and B are real numbers having respective values between 0 and 1 where A<B. In this way the value of A sets the first time constant, or attack time, of the level estimator and B sets the second time constant, or release time.

At the execution of process step 406 the updated level estimate Yp(n) is compared to a previously detected absolute peak level denoted “MaxPeak”. MaxPeak is a peak tracking variable representing a maximum absolute value of the digital audio signal between a pair of consecutive detected zero-crossings of the first or second digital audio signal.

If the updated level estimate, Yp(n), exceeds MaxPeak, the signal selection circuit proceeds to step 407 where the value of Maxpeak is updated by setting it equal to the updated level estimate Yp(n). On the other hand, if the updated level estimate, Yp(n), is smaller than the current MaxPeak, the signal selection circuit skips process step 407 and proceeds to process step 408 so that the current value of Maxpeak remains unchanged.

The signal selection circuit proceeds to execute process step 408 to monitor both of the first and second amplified audio signals for detecting a substantially simultaneous zero-crossing. As mentioned above, a zero-crossing may be determined in variety of ways for each of the first and second amplified audio signals, e.g. based on the output signals of respective comparators. If the signal selection circuit fails to detect substantially simultaneous zero crossings in both of the first and second amplified audio signals, the process jumps to process step 414. In process step 414 a current setting of the state variable “State” is read. The signal selection circuit sets in response the output state of the signal selector 122 cause a switch, e.g. switch 111 of FIGS. 1 and 2, to convey the amplified audio signal indicated by the state variable, i.e. either the first amplified audio signal supplied by ch1 or the second amplified audio signal supplied by ch2.

On the other hand, if the signal selection circuit in process step 408 detects a substantially simultaneous zero-crossing of the first and the second amplified audio signals, it proceeds to process step 409 where the signal selection circuit determines whether the current MaxPeak value is larger than a first predetermined threshold level “Threshold 1” which is an upper threshold level of two separate threshold levels utilized in the present embodiment of the invention. If the answer is yes (Y), the process or algorithm proceeds to process step 410 and sets the value of the state variable “State” equal to ch2 because the outcome of the previous comparison step 409 indicated that the level of the audio input signal is close to an overload limit of the upper signal channel of the amplification circuit (102 on FIG. 1). The signal selection circuit proceeds from process step 410 to process step 413, where the value of MaxPeak is reset to zero in preparation for a new search for zero-crossings of the first and second amplified audio signals. Thereafter the signal selection circuit proceeds to process step 414 where the current setting of the state variable “State” is detected as ch2. In response, the signal selection circuit in process step 416 subsequently selects to convey or transmit the second amplified audio signal from the lower channel (ch2) to the sigma-delta modulator as indicated by the current setting of the state variable.

On the other hand, if the comparison between the current MaxPeak and the “Threshold 1” in process step 409 results in a no (N), the signal selection circuit proceeds to step 411 where the current MaxPeak is compared to the second predetermined threshold level “Threshold 2” which is lower than “Threshold 1” preferably with an amount between 2 and 6 dB. If the comparison in process step 411 results in a no it indicates that the current value of MaxPeak lies in-between “Threshold 1” and “Threshold 2” and the signal selection circuit proceeds to step 413. This means that updating the value of the state variable “State” is skipped and the current state variable value therefore is retained before proceeding through steps 413, 414, 415/416. On the other hand, if the current MaxPeak is lower than the second predetermined threshold level in process step 411, the signal selection circuit proceeds to process step 412 and sets the value of the state variable “State” equal to ch1 because the outcome of the previous comparison step 411 indicated that the level of the audio input signal is safely below the overload limit of the upper signal channel. Accordingly, the use of two separate threshold levels, i.e. “Threshold 1” and “Threshold 2”, introduces a certain amount of level based hysteresis in the output state switching to prevent rapid random switching between outputting the first and second amplified audio signals.

Embodiments of the method described herein can be implemented by means of hardware comprising several distinct elements, and/or at least in part by means of a suitably programmed microprocessor.

In the apparatus claims enumerating several means, several of these means can be embodied by one and the same element, component or item of hardware. The mere fact that certain measures are recited in mutually different dependent claims or described in different embodiments does not indicate that a combination of these measures cannot be used to advantage.

It should be emphasized that the term “comprises/comprising” when used in this specification is taken to specify the presence of stated features, elements, steps or components but does not preclude the presence or addition of one or more other features, elements, steps, components or groups thereof.

1. An audio amplification circuit comprising:
a first preamplifier having an input operatively coupled to an input terminal of the audio amplification circuit for receipt of an audio input signal and operable to provide a first amplified audio signal with a first signal amplification;
a second preamplifier having an input operatively coupled to an input terminal of the audio amplification circuit for receipt of an audio input signal and operable to provide a second amplified audio signal with a second signal amplification, smaller than the first signal amplification;
a switch having a first input operatively coupled to the first preamplifier, a second input operatively coupled to the second preamplifier, and an output;
an analogue-to-digital converter operatively coupled to the output of the switch and operable to provide a digital audio signal;
a signal selection circuit operable to control the switch to selectively provide one of the first and second amplified audio signals on the output of the switch.

2. An audio amplification circuit according to claim 1, comprising an input terminal for receipt of an audio input signal, wherein the first and second preamplifiers are operatively coupled to said input terminal.

3. An audio amplification circuit according to claim 2, comprising an attenuator operatively coupled in-between the input terminal and an input of the second preamplifier.

4. An audio amplification circuit according to claim 3, wherein the attenuator comprises a resistive or capacitive voltage divider.

5. An audio amplification circuit according to claim 1, comprising a comparator operatively coupled to one of the first and second preamplifiers and operable to detect a zero crossing of the corresponding first or second amplified audio signal, and to provide to the signal selection circuit a detection signal indicative of a detected zero crossing; and wherein the signal selection circuit is operable to use the detection signal to control the switch to switch between conveying the first or second amplified audio signal to the analogue-to-digital converter.

6. An audio amplification circuit according to claim 5, comprising a first comparator operatively coupled to the first preamplifier and operable to detect a zero crossing of the first amplified audio signal, and to provide to the signal selection circuit a first detection signal indicative of a detected zero crossing; a second comparator operatively coupled to the second preamplifier and operable to detect a zero crossing of the second amplified audio signal, and to provide to the signal selection circuit a second detection signal indicative of a detected zero crossing; and wherein the signal selection circuit is operable to use the first and second detection signals to control the switch to switch between conveying the first or second amplified audio signal to the analogue-to-digital converter.

7. An audio amplification circuit according to claim 6, wherein the signal selection circuit is operable to detect a substantially simultaneous zero-crossing of the first and second amplified audio signals and to control the switch to switch between conveying the first or second amplified audio signal to the analogue-to-digital converter at the detected substantially simultaneous zero-crossing of the first and second amplified audio signals.

8. An audio amplification circuit according to claim 1, comprising a signal feature estimation circuit adapted to estimate a signal feature of at least one of the first amplified audio signal, the second amplified audio signal, and the digital audio signal, and to compare the estimated signal feature with a predetermined feature criterion; and wherein the signal selection circuit is adapted to control the switch to switch between conveying the first or second amplified audio signal to the analogue-to-digital converter based on the comparison between the estimated signal feature and the predetermined feature criterion.

9. An audio amplification circuit according to claim 8, wherein the signal feature comprises at least one of a level, a non-linear distortion, a DC level, a noise level, and a spectral feature.

10. An audio amplification circuit according to claim 1, wherein the analogue-to-digital converters comprises a sigma-delta converter adapted to generate the digital audio signal at an oversampled sampling rate, such as a sampling rate between 1 MHz and 10 MHz.

11. An audio amplification circuit according to claim 10, further comprising a decimation filter configured for receipt and down-sampling of the digital audio signal from an oversampled sampling rate to a reduced or Nyquist sampling rate.

12. An audio amplification circuit according to claim 1, comprising an externally accessible output terminal adapted to provide a digital audio stream comprising the digital audio signal.

13. An audio amplification circuit according to claim 12, comprising a digital audio interface operable to receive the digital audio signal and operatively coupled to the externally accessible output terminal, the digital audio interface being configured to convert the digital audio signal at the reduced or Nyquist sampling rate into a digital audio stream compliant with a standardized data communication or digital audio protocol such as I²S, S/PDIF, AES/EBU, SLIMbus™.

14. An audio amplification circuit according to claim 1, wherein the first preamplifier and/or the second preamplifier comprises:
a differential amplifier having a non-inverting input operatively coupled to the input terminal for receipt of the audio input signal,
a feedback network coupled between an output and an inverting input of the differential amplifier.

15. An audio amplification circuit according to claim 14, wherein the feedback network is configured to provide a lowpass transfer function from the output of the differential amplifier to the inverting input of the differential amplifier.

16. An audio amplification circuit according to claim 1, comprising a gain scaling circuit adapted to scale the digital audio signal with a preset or adaptive gain factor; and wherein the signal selection circuit is operable to control the gain scaling circuit to selectively scale the digital audio signal to compensate for an amplification difference between the first and second signal amplifications.

17. A semiconductor die or substrate comprising an audio amplification circuit according to claim 1.

18. A miniature capacitive microphone comprising:
a capacitive transducer element responsive to impinging sound to generate a corresponding transducer signal on a transducer signal terminal,
a semiconductor die or substrate according to claim 17 operatively coupled to the transducer signal terminal via the input pad or terminal for receipt and amplification of the transducer signal.

19. A method of amplifying audio signals comprising:
applying an analogue audio input signal received at an input terminal of an amplification circuit to an input of a first preamplifier,
generating a first amplified output signal by the first preamplifier having a first signal amplification,
applying an analogue audio input signal received at an input terminal of an amplification circuit to an input of a second preamplifier,
generating a second amplified audio signal by second preamplifier having a second signal amplification; wherein the second signal amplification is smaller than the first signal amplification;
selecting one of the first and second amplified audio signals;
converting the selected one of the first and second amplified output signals to a digital audio signal.

20. A method according to claim 19, comprising:
receiving an analogue audio input signal at an input terminal of an amplification circuit,
applying the received analogue audio input signal to an input of the first preamplifier and to an input of the second preamplifier.
